(19) United States
(12) Patent Application Publication
(10) Pub. No.: US 2005/0277092 A1
(43) Pub. Date: Dec. 15, 2005

(54) Motion platform device for spatial disorientation simulation

(76) Inventor: Thong-Shing Hwang, Taichung City (TW)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/857,232

(22) Filed: Jun. 1, 2004

(51) Int. Cl. G09B 9/08; G09B 19/16

(52) U.S. Cl. 434/55; 434/58

(57) ABSTRACT

A motion platform device includes a moving platform which is coupled to a base platform by three pedestals and three linkages. Three actuators are disposed on the base platform and are synchronously movable relative to the base platform along three linear sliding paths, and are connected respectively to the pedestals. The linkages are linked with the moving platform and are respectively coupled to the pedestals so as to transmit movement of the actuators to turn the moving platform. The linkages are controlled by a simulated movement controller to be moved relative to the pedestals along the respective lengths so as to perform flight motion simulation, particularly in spatial disorientation training. This three-leg six DOF linear motor based parallel manipulator has been proved to be excellent in simulation performance, especially in the working space.

### BACKGROUND OF THE INVENTION

1. Field of the Invention

This invention relates to a motion platform device for spatial disorientation simulation, more particularly to a motion platform device with a relatively larger workspace and high-speed motion for improved flight simulation.

2. Description of the Related Art

Referring to FIG. 1, a conventional motion platform device for flight motion simulation is shown to include a moving platform 1 for mounting a simulator 6, a base platform 2 disposed under and spaced apart from the platform 1, and three pairs of hydraulic actuators 3,4,5, which are disposed between the base platform 2 and the platform 1 by universal joints, and each of which can be extended and retracted linearly so as to permit movement of the platform 1 with six degrees of freedom (DOF) (i.e. in three linear displacements and in three angular rotations singly or in any combination). When the operator manipulates a controller (not shown) to actuate the hydraulic actuators 3,4,5, respectively, the platform 1 can be operated to enable the simulator 6 to perform flight motion simulation, such as pitching, rolling and yawing motions.

Since the conventional motion platform device has three pairs of hydraulic actuators 3,4,5, the following drawbacks arise:

1. The six hydraulic actuators 3,4,5 have complicated and costly constructions. Besides, they have to be controlled respectively, thereby resulting in inconvenient operation.

2. The platform 1 is restrained from movement since lower ends of the hydraulic actuators 3,4,5 are mounted/secured to the base platform 2. As such, the workspace of the platform 1 is limited. In particular, as the platform 1 generally can only turn about 30 degrees in each operation, the platform 1 must be operated at least twelve times in order to perform a 360-degree yawing motion for the motion cueing simulation of the spatial disorientation training. As such, turning of the platform 1 is intermittent, which adversely affects the simulation fidelity of the simulator 6.

### SUMMARY OF THE INVENTION

The object of the present invention is to provide a motion platform device which can overcome the drawbacks associated with the prior art.

According to this invention, the motion platform device includes a base platform, a moving platform which is spaced apart from the base platform in an upright direction, and which has a lower surface confronting the base platform, and three mounts that are disposed on the lower surface and that are angularly displaced from one another about a central line which extends in the upright direction, a servomechanism, three pedestals, three linkages, and a simulated movement controller.

The servomechanism includes three drive members and three actuators which are disposed on the base platform. The actuators are angularly displaced from one another about the central line. The actuators are respectively driven by the drive members to be synchronously movable relative to the base platform along first, second and third sliding paths, respectively. The first, second and third sliding paths lie in a horizontal plane normal to the central line.

The pedestals define first, second and third lengths, respectively, in the upright direction. Each of the pedestals has a lower pedestal end which is pivotally mounted on a respective one of the actuators about a respective one of the first, second and third sliding paths, and an upper pedestal end opposite to the lower pedestal end along a respective one of the first, second and third lengths. Each of the linkages has an upper linking end which is linked to a respective one of the mounts, and a lower coupling end which is coupled to the upper pedestal end of a corresponding one of the pedestals and which is movable relative to the upper pedestal end along a corresponding one of the first, second and third lengths. When the actuators are synchronously moved along the first, second and third sliding paths, respectively, the moving platform is turned relative to the base platform in a clockwise direction or in a counterclockwise direction about the central line.

The simulated movement controller is disposed to control respective movements of the linkages relative to the upper pedestal ends along the first, second and third lengths when the linkages transmit synchronized movements of the actuators to the moving platform, thereby permitting the moving platform to perform flight motion simulation and to simulate the motion cueing perception of the spatial disorientation training.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a conventional motion platform device for flight motion simulation;

FIG. 2 is a perspective view of a preferred embodiment of a motion platform device according to this invention;

FIG. 3 is a simplified schematic view of the preferred embodiment;

FIGS. 4 to 7 are simplified schematic views of the preferred embodiment in different flight motion simulating attitudes; and

FIG. 8 is a perspective view of another preferred embodiment of a motion platform device according to this invention.

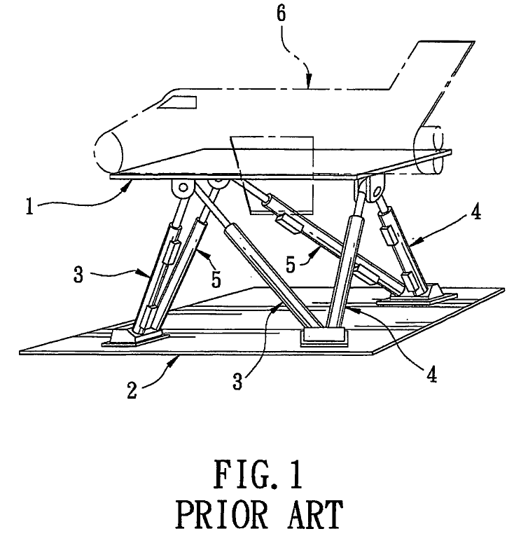

### DETAILED DESCRIPTION OF THE PREFERRED EMBODIMENTS

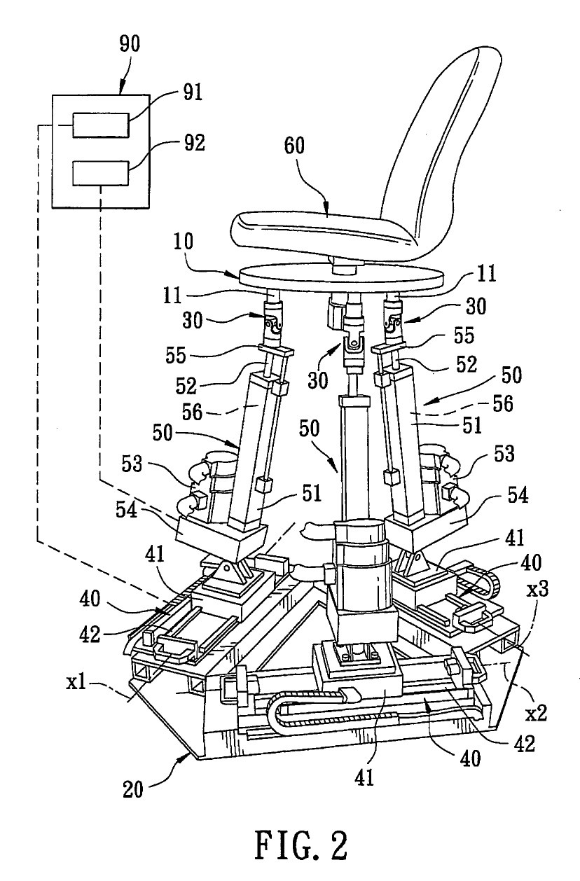

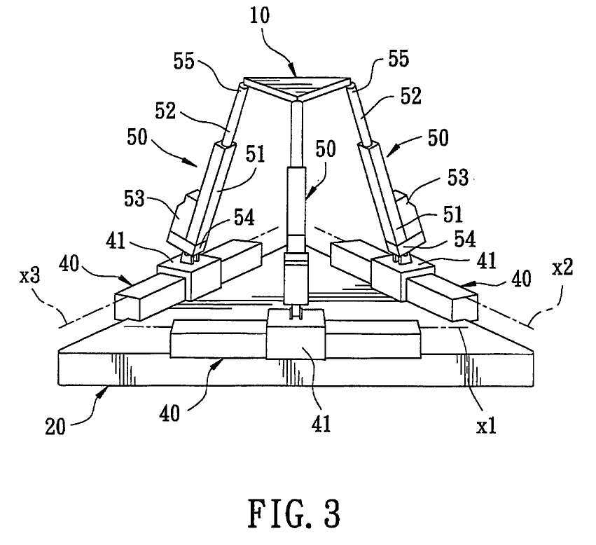

Referring to FIGS. 2 and 3, the preferred embodiment of a motion platform device according to the present invention is shown to comprise a base platform 20, a moving platform 10, a servomechanism with three synchronous linear servomotors 40 disposed on the base platform 20, three pedestals 50, and three universal joints 30.

The moving platform 10 has an area smaller than that of the frame base 20, and is spaced apart from the base platform 20 in an upright direction. The moving platform 10 has a lower surface confronting the base platform 20, and three mounts 11 that are disposed on the lower surface and that are angularly displaced from one another about a central line which extends in the upright direction. The three mounts 11 define three vertices of an upper triangular plane.

The synchronous linear servomotors 40 are displaced from one another about the central line. Each of the synchronous linear servomotors 40 has a magnet track 42 disposed in a respective one of first, second and third sliding paths along first, second and third axes (x1,x2,x3) to serve as a drive member, and a forcer 41. The forcers 41 of the synchronous linear servomotors 40 are respectively driven by the drive members to be synchronously movable relative to the base platform 20 along the first, second and third sliding paths, respectively. The first, second and third sliding paths lie in a horizontal plane normal to the central line, and surround the central line when extending to interconnect with one another to form a triangular plane that is larger than the upper triangular plane defined by the mounts 11. Each of the first, second and third sliding paths has a leading end and a trailing end which is adjacent to the leading end of an adjacent one of the first, second and third sliding paths. The forcers 41 are movable synchronously from the leading ends toward the trailing ends of the respective sliding paths or vice versa.

The pedestals 50 define first, second and third lengths, respectively, in the upright direction. Each of the pedestals 50 has a lower pedestal end 54 which is pivotally mounted on a respective one of the forcers 41 about a respective one of the first, second and third axes (x1,x2,x3), and an upper pedestal end 51 in the form of a tubular cylinder 51 that extends from the lower pedestal end 54 along a respective one of the first, second and third lengths.

Each of the linkages 52 is in the form of a piston shaft, and has an upper linking end 55 that is linked to a respective one of the mounts 11 by the respective universal joint 30 so as to permit free rotation of the mounts 11 relative to the linkages 52, and a lower coupling end 56 that is in the form of a piston which is inserted into and which is driven by an AC induction servomotor 53 to be slidable along the cylinder 51 of the respective pedestal 50 so as to move the respective linkage 52 along a corresponding one of the first, second and third lengths.

The motion platform device further includes a control unit 90. The control unit 90 has a simulated movement controller 92 to control respective movements of the linkages 52 relative to the cylinders 51 along the first, second and third lengths while the linkages 52 respectively transmit synchronized movements of the forcers 41 to the moving platform 10, thereby permitting the moving platform 10 to perform flight motion simulation, and a synchronized movement controller 91 to control the synchronized movement of the forcers 41 so as to turn the moving platform 10 and a seat 60 mounted on the moving platform 10 relative to the base platform 20 in a clockwise direction or in a counterclockwise direction about the central line.

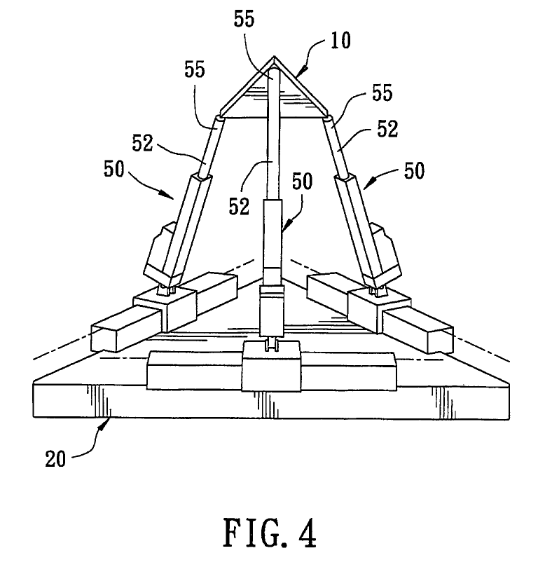

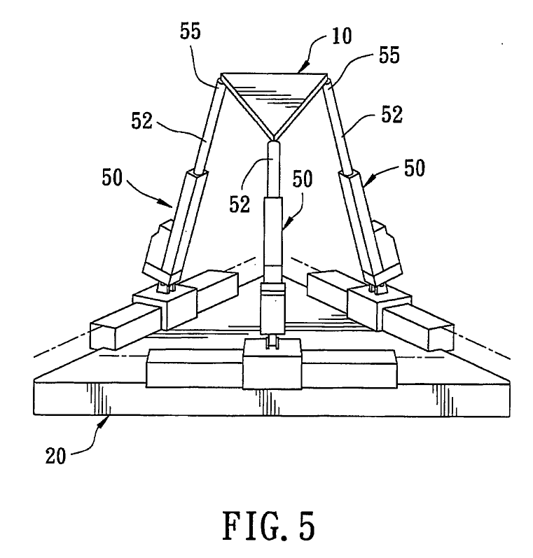

Referring to FIGS. 4 and 5, when one of the linkages 52 is driven to be extended (i.e. the upper linking end 55 is moved away from the corresponding pedestal 50), and the others of the linkages 52 are driven to be retracted (i.e. the upper linking ends 55 are moved toward the corresponding pedestals 50), the moving platform 10 can be tilted forwardly and backwardly relative to the base platform 20 so as to perform a pitching motion simulation.

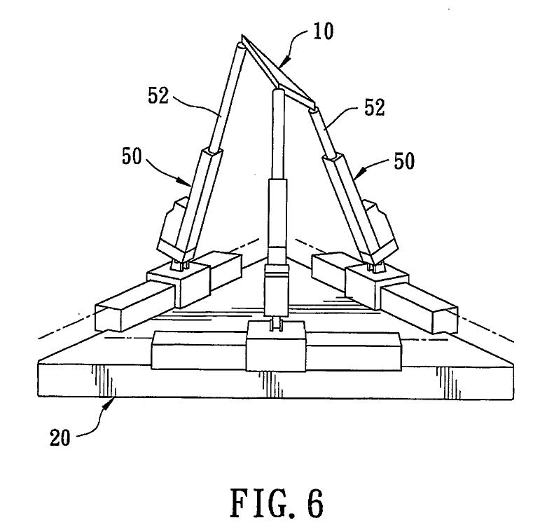

Referring to FIGS. 6, when one of the linkages 52 is driven to be retracted, and one of the linkages 52 is driven to be extended, the moving platform 10 can be tilted rightwardly and leftwardly relative to the base platform 20 so as to perform a rolling motion simulation.

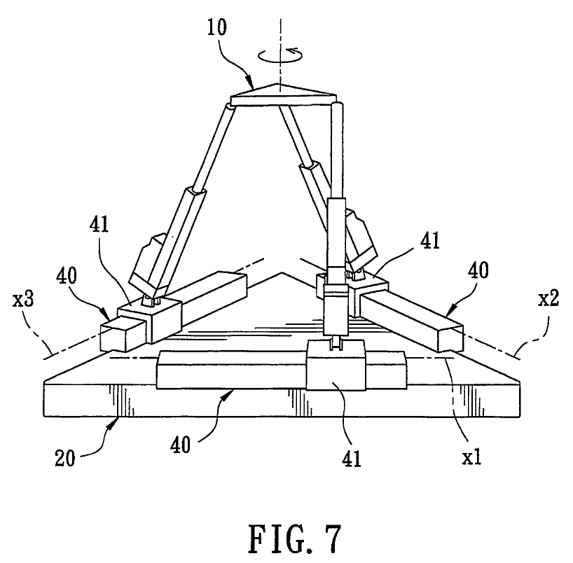

Referring to FIG. 7, when the forcers 41 of the synchronous linear servomotors 40 are moved synchronously and respectively along the first, second and third sliding paths from the leading ends to the trailing ends or from the trailing ends to the leading ends, the moving platform 10 is turned relative to the base platform 20 in a clockwise direction or in a counterclockwise direction about the central line so as to perform a yawing motion simulation.

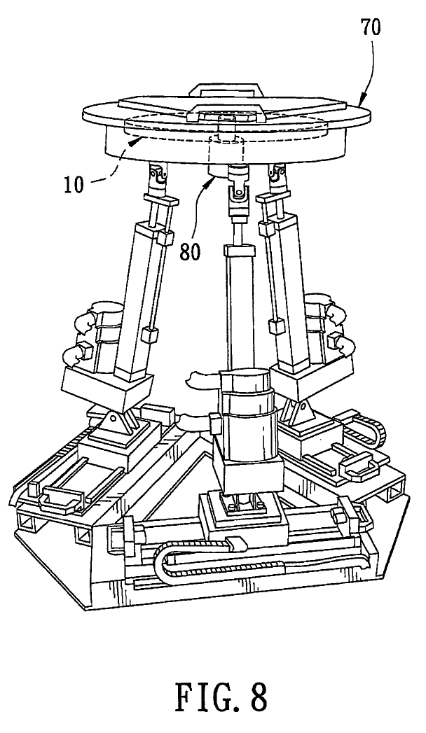

Referring to FIG. 8, another preferred embodiment of a motion platform device according to this invention is shown to be similar to the above embodiment in construction. The motion platform device of this embodiment further comprises a rotary plate 70 which is mounted on the moving platform 10 and which is driven by a driving motor 80 mounted on the lower surface of the moving platform 10 to be rotatable relative to the moving platform 10 about the central line.

As illustrated, the motion platform device of this invention can perform the flight motion simulation with six degrees of freedom. In addition, since the moving platform 10 is moved by means of the linkages 52 which are extended and retracted along the respective lengths and by means of the forcers 41 which are movable along the first, second and third sliding paths, the moving platform 10 can perform such motions as-pitching, rolling and yawing of about 50-60 degrees. Thus, to perform a 360-degree yawing motion simulation, it is only necessary to operate the moving platform 10 about six times, thereby resulting in substantially continuous turning of the moving platform 10 and a more realistic simulation.

Moreover, since the pitching and rolling motions of the moving platform 10 are controlled by the AC induction servomotors 53, and since the yawing motion of the moving platform 10 is controlled by the synchronous linear servomotors 40, the controlling of the controller 90 is relatively simple and better. Furthermore, the motion platform device of this invention is convenient to assemble, and can be manufactured at a relatively low cost.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A motion platform device for spatial disorientation
simulation, comprising:
a base platform;
a moving platform which is spaced apart from said base platform in an upright direction, and which has a lower surface confronting said base platform, and three mounts that are disposed on said lower surface and that are angularly displaced from one another about a central line which extends in the upright direction;
a servomechanism including
three drive members disposed on said base platform, and
three actuators which are disposed on said base platform, and which are angularly displaced from one another about the central line, said actuators being respectively driven by said drive members to be synchronously movable relative to said base platform along first, second and third sliding paths, respectively, the first, second and third sliding paths lying in a horizontal plane normal to the central line and surrounding the central line when extending to interconnect with one another to cooperatively form a triangular plane, each of said first, second and third sliding paths having a leading end and a trailing end which is adjacent to said leading end of an adjacent one of the first, second and third sliding paths such that said actuators are movable synchronously from said leading ends toward said trailing ends of the respective first, second and third sliding paths, or vice versa;
three pedestals defining first, second and third lengths, respectively, in the upright direction, each of said pedestals having a lower pedestal end which is pivotally mounted on a respective one of said actuators about a respective one of the first, second and third sliding paths, and an upper pedestal end opposite to said lower pedestal end along a respective one of the first, second and third lengths;
three linkages, each of which has an upper linking end that is linked to a respective one of said mounts, and a lower coupling end that is coupled to said upper pedestal end of a corresponding one of said pedestals such that when said actuators are synchronously moved along the first, second and third sliding paths, respectively, from said leading ends toward said trailing ends or from said trailing ends toward said leading ends, said moving platform is turned relative to said base platform in a clockwise direction or in a counterclockwise direction about the central line, said lower coupling end being disposed to be movable relative to said upper pedestal end along a corresponding one of the first, second and third lengths; and
a simulated movement controller disposed to control respective movements of said linkages relative to said upper pedestal ends along the first, second and third lengths when said linkages transmit synchronized movements of said actuators to said moving platform, thereby permitting said moving platform to perform flight motion simulation.

2. A motion platform device of claim 1, wherein said servomechanism includes three synchronous linear servomotors, each of which has a forcer to serve as a respective one of said actuators, and a magnet track disposed in the respective one of said first, second and third sliding paths to serve as a respective one of said drive members, said motion platform device further comprising a synchronized movement controller which is disposed to control the synchronized movement of said forcers.

3. A motion platform device of claim 1, wherein said upper pedestal end of each of said pedestals is in form of a cylinder extending along the corresponding one of the first, second and third lengths, and said lower coupling end of said linkages is in form of a piston which is inserted into and which is slidable along said cylinder so as to move a respective one of said linkages along the corresponding one of the first, second and third lengths relative to a respective one of said pedestals.

4. A motion platform device of claim 1, further comprising three universal joints, each of which interconnects said upper linking end of the respective one of said linkages and the respective one of said mounts so as to permit rotation of said mounts relative to said linkages.

5. A motion platform device of claim 1, further comprising a rotary plate which is mounted on said moving platform and which is rotatable about the central line relative to said moving platform.

6. A motion platform device of claim 1, wherein said mounts define three vertices of an upper triangular plane that is smaller than the triangular plane formed by said first, second and third sliding paths.
